(19) United States
(12) Patent Application Publication
(10) Pub. No.: US 2026/0370895 A1
(43) Pub. Date: Nov. 19, 2026

(54) SYSTEM AND METHOD FOR CONTENT GENERATION AND DELIVERY

(71) Applicant: Bytedance Technology Ltd., Grand Cayman (KY)

(72) Inventors: Yayun Wang, Beijing (CN); Wenyu Guo, Beijing (CN); Yu Tian, Beijing (CN); Xiang Lai, Beijing (CN); Yongzhen Kang, Beijing (CN); Yixiang Cao, Beijing (CN)

(21) Appl. No.: 19/206,963

(22) Filed: May 13, 2025

(51) Int. Cl. H04N 21/254; G06Q 30/0601; H04N 21/2187; H04N 21/81

(52) U.S. Cl. CPC H04N 21/2542; G06Q 30/0641; H04N 21/2187; H04N 21/812

(57) ABSTRACT

A computing system includes processing circuitry and memory storing a content generation and delivery program that, when executed by the processing circuitry, causes the processing circuitry to: obtain a seller offering authorization and seller settings on content generation. The processing circuitry is also configured to select content-forming components including a seller offering and a plurality of media components for content generation from a database. The processing circuitry is also configured to determine a target audience based on the seller settings on content generation, and generate content that illustrates and/or describes the selected seller offering based on the selected media components, the seller settings on content generation, and the target audience. The processing circuitry is further configured to deliver the generated content to one or more media platforms with platform specific campaign metadata for distribution of the generated content to a plurality of user devices associated with the target audience.

### BACKGROUND

With the development of the Internet, as well as e-commerce and social media technologies, delivering digital content to a target audience has become an effective way of attracting users and expanding businesses. Conventional content generation and delivery technologies heavily rely on human operations, which result in low efficiency and therefore cannot be executed at a large scale automatically. Moreover, different media platforms or data channels have different operational characteristics and/or use different information, which renders it challenging to perform cross-platform content delivery. Thus, there is a need for an improved content generation and delivery system.

### SUMMARY

According to one aspect of the present disclosure, a computing system is provided. The computing system includes processing circuitry and memory storing a content generation and delivery program that, when executed by the processing circuitry, causes the processing circuitry to obtain, through a seller interface, a seller offering authorization and seller settings on content generation. The processing circuitry is also configured to select, through a content-forming component selection engine, content-forming components including a seller offering and a plurality of media components for content generation from a database in response to the seller offering authorization and based on the seller settings on content generation. The processing circuitry is also configured to determine, through an audience matching engine, a target audience based on the seller settings on content generation. The processing circuitry is also configured to generate, through a content generation and delivery engine, content that illustrates and/or describes the selected seller offering based on the selected media components, the seller settings on content generation, and the target audience. The processing circuitry is further configured to deliver, through the content generation and delivery engine, the generated content to one or more media platforms with platform specific campaign metadata for distribution of the generated content to a plurality of user devices associated with the target audience.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system configured to implement a method for automatically generating and delivering content.

FIG. 2 shows a schematic view of the overall process of content generation and delivery performed by various components of the computing system of FIG. 1.

FIG. 3 shows a schematic view of example functional structure of various engines of the computing system of FIG. 1.

FIG. 4 shows a schematic view of an example implementation of standardized input and output parameters for the content-forming component selection engine of the computing system of FIG. 1.

FIG. 5 shows a schematic view of a platform-independent access template and a platform-specific access template generated by the content generation and delivery module of the computing system of FIG. 1.

FIG. 6 shows a schematic view of a process of associating a device identification with selected user interactions with displayed content along a data path, which is performed by the computing system of FIG. 1.

FIG. 7 is a flowchart of an example method for dynamically allocating an amount of content to be delivered, which is performed by the computing system of FIG. 1.

FIG. 8 is a flowchart of an example method for automatic content generation and delivery, which is performed by the computing system of FIG. 1.

FIG. 9 schematically shows an example computing environment of the present disclosure.

### DETAILED DESCRIPTION

Delivering digitally created content to media platforms for distributing to user devices (e.g., TVs, phones, computers, display devices, etc.) has become an effective way for attracting audiences and businesses. An example of content generation and delivery is advertising. Effective advertising can help business attract customers. For an e-commerce business, it is often desirable to place a large number of advertisements on multiple social media platforms in order to purchase data traffic and boost sales. When an e-commerce business is in an early growth stage, the user base is relatively small, and its growth often faces two major challenges: low labor efficiency and insufficient refinement of advertisement strategies. Labor inefficiency limits the volume of online advertisement placement, resulting in underutilized budgets and slowed growth. If agents are hired to assist with advertising, extra costs and ineffectiveness in strategy implementation can undermine the cost-effectiveness. Cross-platform delivery of advertisements suffers from fragmented data and unrefined strategies, resulting in low user conversion rates and high customer acquisition costs. Therefore, there is a need to develop a content generation and delivery system and method suitable to support strong business growth and sustainability of return on investment.

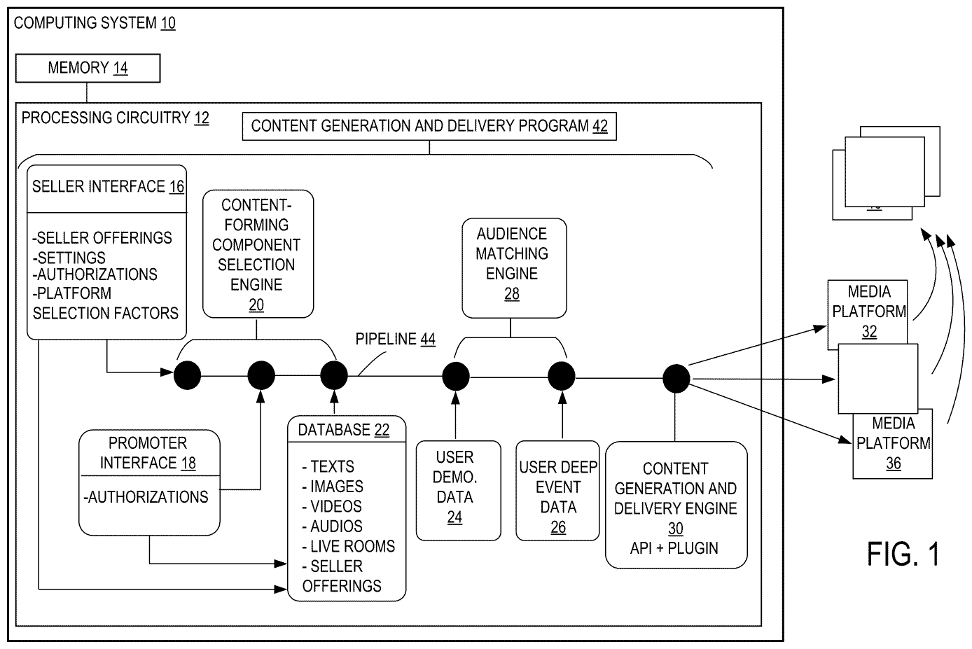

FIG. 1 shows a schematic view of an example computing system 10 for automatically and dynamically generating content and delivering the generated content to one or more media platforms 32, 34, and 36 with platform specific campaign metadata for distribution of the generated content to a plurality of user devices 40. The content may be digitally created content that includes at least one of an audio content item, a video content item, an image content item, a text content item, etc. The computing system 10 includes processing circuitry 12 and memory 14 storing instructions for a content generation and delivery program 42 that, when executed by the processing circuitry 12, causes the processing circuitry 12 to perform a method for automatically and dynamically generating content and delivering the generated content to the one or more media platforms 32, 34, and 36 with minimized operator intervention.

As shown in FIG. 1, the content generation and delivery program 42 defines a pipeline 44 that includes a plurality of nodes (represented by the solid black dots), each node being associated with an operation performed by one or more of a content-forming component selection engine 20, an audience matching engine 28, and a content generation and delivery engine 30. The pipeline may be a directed acyclic graph that defines a root node and destination node, with the output of each node in the pipeline being passed as input to the next node in the pipeline. The processing circuitry 12 is configured to execute the content generation and delivery program 42 that programmatically performs or causes the performance of the selecting of the content-forming components through the content-forming component selection engine 20, the determining of the target audience through the audience matching engine 28, the generating of the content, and the delivering of the generated content through the content generation and delivery engine 30.

The computing system 10 may include one or more personal computers, server computers, cloud computers, tablet computers, home-entertainment computers, network computing devices, video game devices, mobile computing devices, mobile communication devices (e.g., smartphone), vehicle-mounted computers, and/or other computing devices, and wearable computing devices such as smart watches and head mounted displays. Each of the media platforms 32, 34, 36 may be a computing system executing a computer program or application (or App), which may be installed on user devices (e.g., phones, computers) to provide a digital platform for users to interact with one another, share experience, and/or make purchases of products and services. The media platform may be a social media platform, an entertainment media platform, a sports media platform, or any suitable digital content distribution platform that distributes digital content to the user devices 40 and causes the digital content to be displayed on the user devices. After viewing the content that promotes a product or service, users of the user devices 40 may make purchases of the promoted product or service. The user devices 40 may be any suitable user terminal devices, such as TVs, display devices, cell phones, computers, game consoles, tablets, etc. Each user device 40 may include a screen or display (e.g., a touch screen) for displaying the digital content generated and delivered by the computing system 10.

The processing circuitry 12 may be any suitable device configured to process data, information, or signals. The processing circuitry 12 may include both hardware and software components, such as one or more of a processor, an electric circuit, a logic gate, program codes or modules, etc. The processor may be any suitable processor, such as a central processing unit (CPU), a graphics processing unit (GPU), a digital signal processing device, an application specific integrated circuit (ASIC), a system on chip (SOC), a field-programmable gate array (FPGA), a logic circuit, or other suitable type of microprocessor configured to perform the functions recited herein. The term “memory” as used herein broadly encompasses any suitable data storage device or non-transitory computer-readable storage medium. For example, the memory 14 may be a random-access memory, a read-only memory, a flash memory, a static random-access memory (SRAM), a dynamic random-access memory (DRAM), a magnet tape, a hard disk, a solid state disk, an optic disk, or a combination thereof.

When executed by the processing circuitry 12, the content generation and delivery program 42 causes the processing circuitry 12 to obtain, through a seller interface 16, a seller offering authorization and seller settings on content generation. The seller interface 16 may be a user interface, such as a graphical user interface, which may be rendered by the content generation and delivery program 42. The seller interface 16 may be configured to enable a seller (or merchant) to provide various input, such as to provide a list of seller offerings, settings on content generation, seller offering authorizations on the seller offerings, platform selection factors, etc. The term “seller offering” broadly encompasses a product and/or a service offered by the seller. For example, through the seller interface 16, the seller may provide a list of products (e.g., fruits, clothes, shoes, food, etc.). The seller may wish to promote some or all of the listed products. The seller may provide seller offering authorizations to indicate whether a specific product or service is authorized to be promoted. The seller may also configure seller settings on content generation, such as seller preferred promoter(s), seller budget for content (e.g., advertisement), seller preferred target audience, which may further specify audience selection criteria, such as demographic characteristics of users and deep event statistical thresholds. The seller may further provide one or more platform selection factors that may function as criteria for selecting which media platform(s) to select for delivering the generated content that promotes the seller's product or service. Examples of the one or more media platform selection factors may include a media platform name, a minimum number of registered users of the media platform, a minimum amount of total gross sales values of the media platform within a pre-set time period, a minimum amount of traffic of the media platform within a pre-set time period, demographic factors of users of the media platform, etc. Information configuration through the seller interface 16 may be enabled by providing suitable input interfaces, such as buttons, boxes, lists/menus, text input spaces, etc., on the seller interface 16. In some examples, the platform selection factors and/or the seller offering authorizations may also be included as parts of the seller settings on content generation.

The processing circuitry 12 is further configured to, when executing the content generation and delivery program 42, obtain, through a promoter interface 18, a promoter authorization. A promoter is a user of a media platform who has a capability of promoting a seller offering, such as a product. The promoter may be associated with a real person or may be a computer-generated virtual person. In a typical scenario, a promoter has a relatively large number of followers. The promoter or the promoter's team may create videos, audios, articles/texts, and/or may conduct live streaming to promote products or services. The promoter authorization may include an authorization form the promoter or the promoter's team for the computing system 10 to use the promoter's name, photos/images, other media components created by, or otherwise involving or related to the promoter, and/or a live streaming virtual room associated with the promoter. A live streaming virtual room is a virtual broadcasting room in which a user (e.g., the promoter) performs live streaming to introduce or sell a product or service to his/her followers and non-follower audiences.

The processing circuitry 12 is further configured to, when executing the content generation and delivery program 42, select, through the content-forming component selection engine 20, content-forming components including a seller offering and a plurality of media components for content generation from a database 22 in response to the seller offering authorization and based on the seller settings on content generation. The content-forming component selection engine 20 may be a software module of the content generation and delivery program 42. The database 22 is configured to store a plurality of content-forming components including one or more seller offerings, one or more links to one or more live streaming virtual rooms, videos, audios, images, and/or texts. The one or more links to the one or more live streaming virtual rooms, videos, audios, images, and/or texts may be collectively referred to as media components. When selecting the media components, the content-forming component selection engine 20 may select an image and/or a video describing or illustrating the selected seller offering (e.g., a product), and/or may select other images and/or videos that may not directly describe or illustrate the selected seller offering.

In an example, the seller offering authorization may indicate that a first product is authorized to be promoted in content to be generated, and a second product is not authorized to be promoted in content to be generated. The database 22 may store a list of seller offerings, such as a list of products offered by the seller. Based on the seller offering authorization, the content-forming component selection engine 20 may select the first product from the list of seller offerings for content generation, and may not select the second product. Once the seller offering is selected for content generation, the content-forming component engine 20 may also select one or more media components described above from the database 22. In some examples, the processing circuitry 12 is further configured to select, through the content-forming component selection engine 20, one or more media components related to a promoter based on the promoter authorization. The one or more media components related to the promoter may be a link to a live streaming virtual room operated by the promoter, a video and/or an image involving the promoter, etc. The one or more media components related to the promoter may also be used for generating the content to be delivered to the media platforms 32, 34, 36, and further to the user devices 40.

The processing circuitry 12 is further configured to, when executing the content generation and delivery program 42, determine, through the audience matching engine 28, a target audience based on the seller settings on content generation. The audience matching engine 28 may be a software module of the content generation and delivery program 42. Some seller settings on content generation may be selected to form audience selection criteria. For example, the audience selection criteria may be formed based on seller settings such as seller preferred user demographic data, seller preferred deep events statistical thresholds, seller preferred media platforms.

When executing the content generation and delivery program 42 to determine the target audience, the processing circuitry 12 is also configured to generate audience groups and deep event statistics that reflect historical user interactions with historically displayed content. In an example, the audience groups may be generated based on user demographic data 24. The user demographic data 24 may include typical demographic data depicting a profile of a user, such as age, gender, location, hobby, career, categories of favorites (e.g., food, music, movies, etc.). Depending on the audience selection criteria, in some examples, one or more specific audience groups may be selected to form a target audience, or users from different audience groups may be selected to form a target audience.

The audience matching engine 28 may generate deep event statistics that reflect the historical user interactions with the historically displayed content based on user deep event data 26. A deep event may include a significant action taken by the user related to the displayed content. A deep event may include, for example, a user making a first purchase of a product or service promoted by the displayed content, a user signing up a subscription to use a product or service, a user completing a form (such as a survey form relating to a product or service), a user adding a product or service to a shopping cart, a user completing a purchase of a product or service, a user making a payment, etc. The deep event data 26 may also include other user behavior or interaction data, such as a time period a user stayed on a specific displayed page that includes the generated content, a number of page scrolling actions performed by a user, etc. The deep event statistics may include various forms, such as average values, total values, standard deviations, estimated values, etc. Users having demographic data and deep event statistics that satisfy the audience selection criteria may be selected to form the target audience. Although not shown in FIG. 1, the user demographical data 24 and the user deep event data 26 may be stored in the database 22.

When executing the content generation and delivery program 42, the processing circuitry 12 is configured to generate, through the content generation and delivery engine 30, content that illustrates and/or describes the selected seller offering based on the selected media components, the seller settings on content generation, and the target audience. In some examples, the seller settings on content generation include a media platform selection factor. The processing circuitry 12 is configured to deliver, through the content generation and delivery engine 30, the generated content to the one or more media platforms 32, 34, 36 with platform specific campaign metadata for distribution of the generated content to the plurality of user devices 40 associated with the target audience.

Because different media platforms 32, 34, 36 may implement different operations and/or use different information for receiving content from an external system (e.g., computing system 10) and for distributing the content to the user devices 40, in some examples, the processing circuitry 12 is configured to, when executing the content generation and delivery program 42, generate a platform-independent access template for different media platforms, wherein the platform-independent access template includes common operations or information related to different application programming interfaces for different media platforms. In some examples, the common operations or information of the platform-independent access template may include names (e.g., names of media platforms), budgets (e.g., budgets set by the media platforms), bids (e.g., bids for distributing the content to users of the media platforms), accounts (financial accounts associated with the media platforms or other pertinent accounts), etc. In some examples, the processing circuitry 12 is also configured to, when executing the content generation and delivery program 42, generate platform-specific templates for non-common operations or information associated with different media platforms. An example of the non-common operations or information may be referred to as channel differentiated information, such as channel or platform specific media components, channel or platform specific audience, etc.

In some examples, the different media platforms 32, 34, 36 may be replaced by different data channels implemented by a same media platform. In such a scenario, the content generation and delivery engine 30 of the computing system 10 may directly distribute the generate content to the user devices 40 through the different data channels.

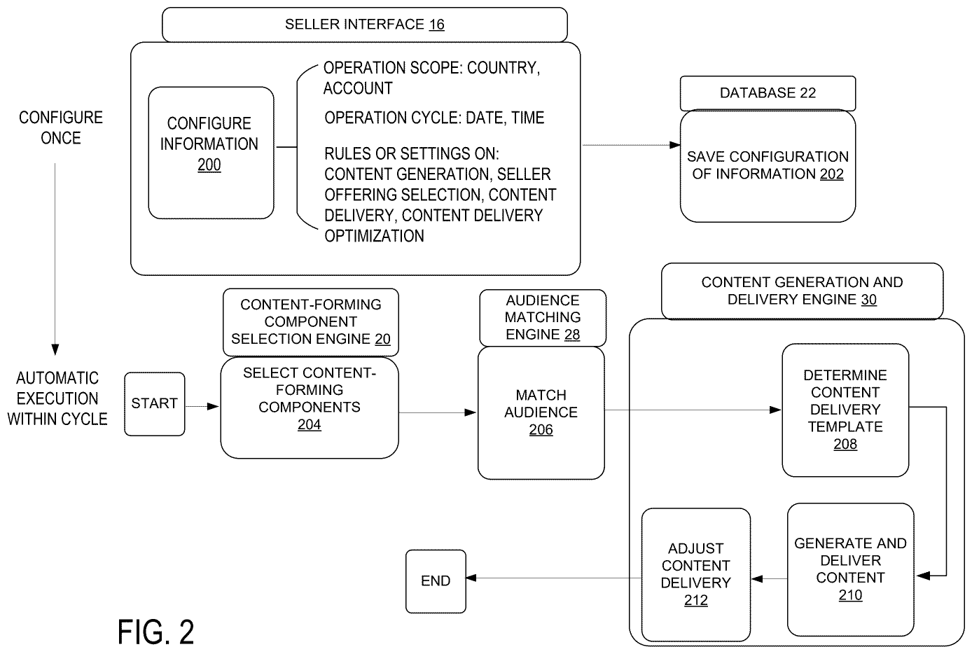

FIG. 2 shows a schematic view of the overall process of content generation and delivery performed by various components of the computing system 10 of FIG. 1. It is noted that FIG. 2 may not show all of the detailed processes or steps for automatic content generation and delivery. The processes, steps, and/or structures shown in FIG. 2 are intended to provide additional details for the elements and processes shown in FIG. 1. To achieve automatic content generation and delivery, some basic information may be configured once, either manually by an operator or a seller, or automatically by an algorithm. After the basic information is configured, various steps 204-212 may be automatically and periodically performed by various engines of the computing system 10 to select content-forming components, match audiences, generate and deliver content to one or more media platforms 32, 34, 36 for distributing to the user devices 40. The disclosed computing system 10 can implement automatic content generation and delivery with minimized operator intervention, thereby significantly increasing content delivery efficiency.

As shown in FIG. 2, a seller or an operator may configure basic information through the seller interface 16 (step 200), or an algorithm may be executed by the computing system 10 to automatically configure the basic information through the seller interface 16. The configured basic information may be saved in the database 22 (step 202). The configured basic information shown in FIG. 2 is exemplary, which may include operation scope: country, account; operation cycle: date, time; rules or settings on: content generation, seller offering selection, content delivery, and content delivery optimization, etc. Additional information, rules, and/or settings related to content generation and delivery may also be configured.

After the basic information is configured and saved, the computing system 10 may automatically and dynamically generate content and deliver the generated content to one or more media platforms 32, 34, 36 and further to the user devices 40 in a predetermined cycle (i.e., time period). During automatic execution of content generation and delivery in a cycle, the processing circuitry 12 is configured to automatically select content-forming components through the content-forming component selection engine 20 (step 204). For example, the content-forming component selection engine 20 may automatically select a seller offering (e.g., a product) based on a seller offering authorization, and select a plurality of media components. The selected seller offering and media components may be included in the content to be generated configured to promote the seller offering. In some examples, the database 22 may store a plurality of seller offerings (e.g., a plurality of products), and each seller offering may be associated with a seller offering identification (e.g., a product identification). The database 22 may also store a plurality of media components (e.g., videos, images, texts, links to live streaming virtual rooms), and each media component may be associated with a media component identification. The seller offering identification and/or the media component identification may include a name and/or an identification number. The content-forming component selection engine 20 may output a content-forming component identification (e.g., a product identification and/or a media component identification), which may be passed on to the audience matching engine 28. The audience matching engine 28 is configured to match candidate audiences (step 206) with audience selection criteria formed based on the selected content-forming components and other information, such as a promoter authorization, seller settings on content generation and/or delivery, a seller offering authorization, etc.

In some examples, each user or each group of users may have an audience identification, which may include a name and/or an identification number. Based on the audience selection criteria, the audience matching engine 28 may determine a target audience that include users that satisfy the audience selection criteria. The target audience may be associated with an audience identification. The audience matching engine 28 may output the audience identification of the target audience. The audience identification and the content-forming component identifications may be passed on to the content generation and delivery engine 30. The content generation and delivery engine 30 is configured to determine one or more content delivery templates (step 208) associated with one or more media platforms. A content delivery template may include a platform-independent access template and a platform-specific access template, which will be described in detail below. The content delivery template may include a name and/or an identification of a media platform. Based on the one or more content delivery templates, the content-forming component identifications, and the audience identification of the target audience, the content generation and delivery engine 30 generates content and delivers the generated content to the one or more media platforms 32, 34, 36 (step 210). The one or more media platforms 32, 34, 36 then distribute the content to the user devices 40 associated with the target audience. The content generation and delivery engine 30 is further configured to adjust content delivery (step 212). For example, the content generation and delivery engine 30 may dynamically collect or receive feedback data associated with the content delivered to the user devices 40, and analyze the feedback data to dynamically calculate a content delivery effectiveness measurement, which may be based on, for example, the gross merchandise volume, the content conversion rate, and/or the return on investment. Based on the calculated content delivery effectiveness measurement, the content generation and delivery engine 30 may dynamically adjust quantities of content deliveries for different media platforms and/or may adjust traffic allocation to different media platforms and/or different user devices to optimize the content delivery effectiveness measurement. The steps of 204-212 may be repeatedly and automatically executed within a predetermined cycle or multiple cycles with no or minimal operator intervention. As a result, the efficiency of content generation and delivery is enhanced. For example, when the content generation and delivery is related to targeted advertising, the computing system 10 may automatically select a product offered by a seller, select media components, determine a target audience, and generate advertisements to promote the product. The computing system 10 may automatically deliver the generated advertisements to the media platforms 32, 34, 36, for distribution to the user devices 40 associated with the targeted audience.

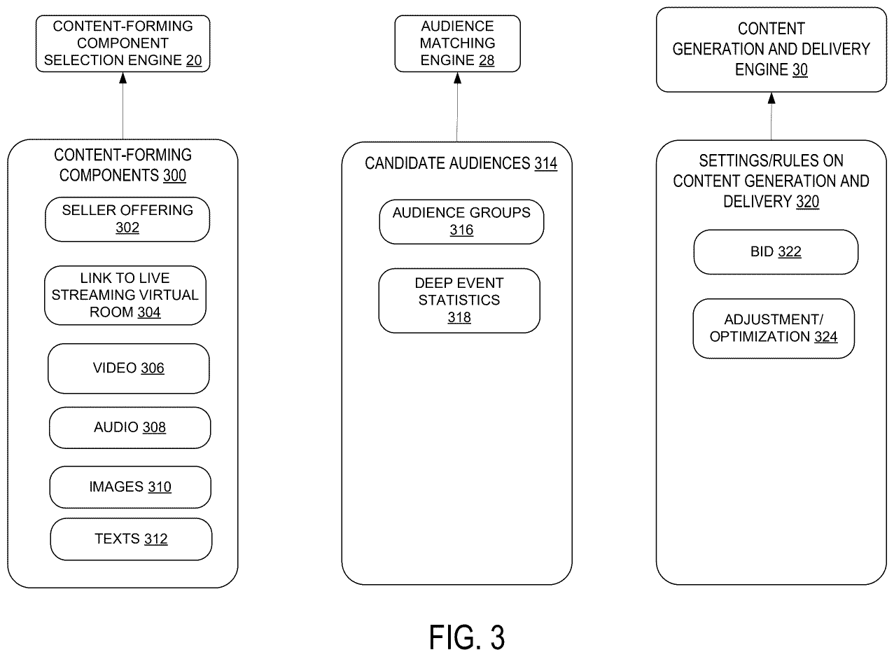

FIG. 3 is a schematic view of operations performed and/or information used or generated by various engines of the computing system 10 of FIG. 1. As shown in FIG. 3, the content-forming component selection engine 20 may select one or more content-forming components 300 for generating content. The content-forming components 300 may include a seller offering 302 (such as a product or service), and a plurality of media components. The media components may include one or more links to one or more live streaming virtual rooms 304, videos 306, audios 308 (e.g., music, voices), images 310 (e.g., photos, computer-generated graphs), and/or texts 312. For example, the content-forming component selection engine 20 may select a product from a list of products, an image of the product, a video, a music composition, and a link to a live stream virtual room for generating content to promote the product.

The audience matching engine 28 is configured to determine a target audience from a pool of candidate audiences 314. In some examples, the audience matching engine 28 may generate a plurality of audience groups 316 based on demographic characteristics of users. The demographic characteristics of the users may include, for example, ages, genders, locations, hobbies, careers, sports, food, music, outdoor activities, etc.

The audience matching engine 28 may also generate deep event statistics 318 that reflect historical user interactions with historically displayed content. The audience matching engine 28 may receive or retrieve historical deep event data from the database 22 that reflect historical user interactions with historically displayed content. The audience matching engine 28 may analyze the deep event data to generate statistics of the deep event data. The deep event data may include any suitable data that reflect certain actions taken by users, such as an average time spent by users on a specific content display page, total transactions made by users for a product promoted in displayed content, average number of landing pages clicked through by the users before a purchase of a product promoted in the displayed content is made, etc. The audience matching engine 28 may select a target audience based on seller specified audience selection criteria or audience selection criteria generated or implemented by the audience matching engine 28. The target audience may be selected from a specific audience group or from multiple audience groups. In some examples, the target audience selected from multiple audience groups may form a new audience group. As an example, the audience matching engine 28 may select users from a specific audience group or different audience groups, who have made purchases of advertised products over a predetermined transaction amount in the last 14 days.

The content generation and delivery engine 30 generates content and delivers the generated content to one or more media platforms 32, 34, 36 based on settings and/or rules on content generation and/or delivery 320, which may include the seller settings on content generation and delivery configured by the seller, and/or other settings, rules, or information related to the content generation and delivery. For example, the content generation and delivery engine 30 may determine an amount of content (e.g., a number of advertisements) to be generated and delivered based on a bid 322, which may be set by a seller and/or a media platform. The content generation and delivery engine 30 may perform adjustment and/or optimization 324 on the content generation and delivery dynamically based on a dynamically calculated content delivery effectiveness measurement, which may be based on a gross merchandise volume, a content conversion rate, and/or a return on investment. Other settings or rules on content generation and delivery not shown in FIG. 3 may also be included.

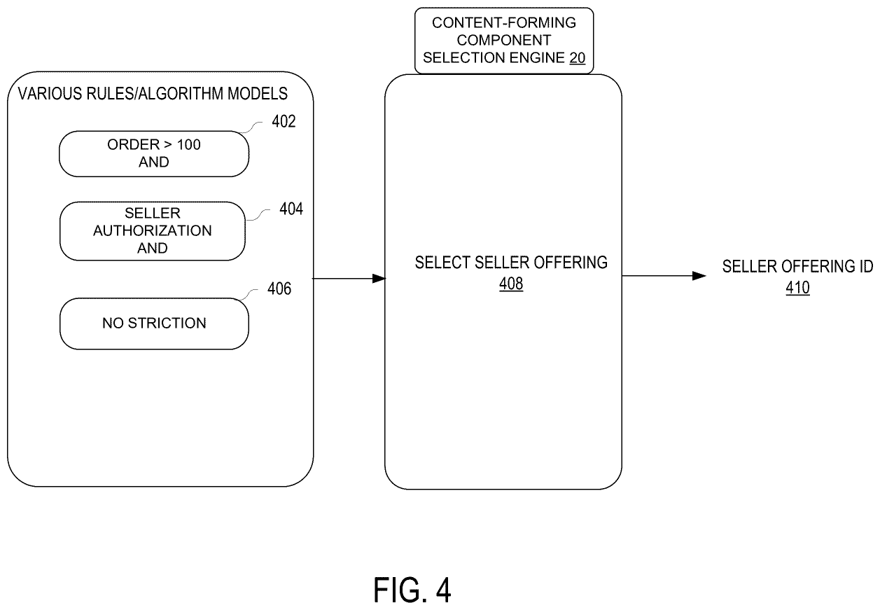

FIG. 4 shows a schematic view of an example implementation of standardized input and output parameters by the computing system 10 of FIG. 1. The example implementation is for the step of selecting a seller offering performed by the content-forming component selection engine 20. Various rules/algorithm models implemented by various data channels and/or different media platforms 32, 34, 36, may use different input parameters for the content-forming component selection engine 20 to determine how to select content-forming components. In the present disclosure, the input parameters for the content-forming component selection engine 20 are standardized. For example, the standardized input parameters for the content-forming selection engine 20 to select a seller offering 408 may include a first standardized input parameter 402 (e.g., number of orders>100), a second standardized input parameter 404 (e.g., a seller offering authorization is in place), and a third standardized input parameter 406 (e.g., no restriction on the seller offering for promotion). In some examples, the computer system 10 may analyze different rules and/or algorithm models implemented at different media platforms 32, 34, 36 to abstract or extract a pre-set number of input parameters as the standardized input parameters. The standardized input parameters may be common and/or most significant input parameters used in different media platforms 32, 34, 36. The standardized input parameters may function as selection criteria for selecting content-forming components (such as seller offerings and/or media components) for generating content. In the example shown in FIG. 4, for the step of selecting a seller offering (e.g., a product offered by the seller), based on the standardized input parameters, the content-forming component selection engine 20 may select a seller offering 408, and may output a standardized output parameter, such as a seller offering identification 410 (e.g., a product identification). Standardizing input parameters and output parameters may also be implemented for other processes performed by various engines of the computing system 10. For example, for the step of selecting (or determining) a target audience, the standardized input parameters for the audience matching engine 28, which may function as selection criteria for selecting a target audience, may include a predetermined demographic criterion (e.g., age, gender, location, hobby, career, sport, etc.), and/or a predetermined deep event statistics threshold (e.g., a minimum quantity of on-line purchases of advertised products), etc. The standardized output parameter for the step of determining a target audience may be an audience identification (e.g., an audience group identification or identification numbers referring to a plurality of specific users or user devices).

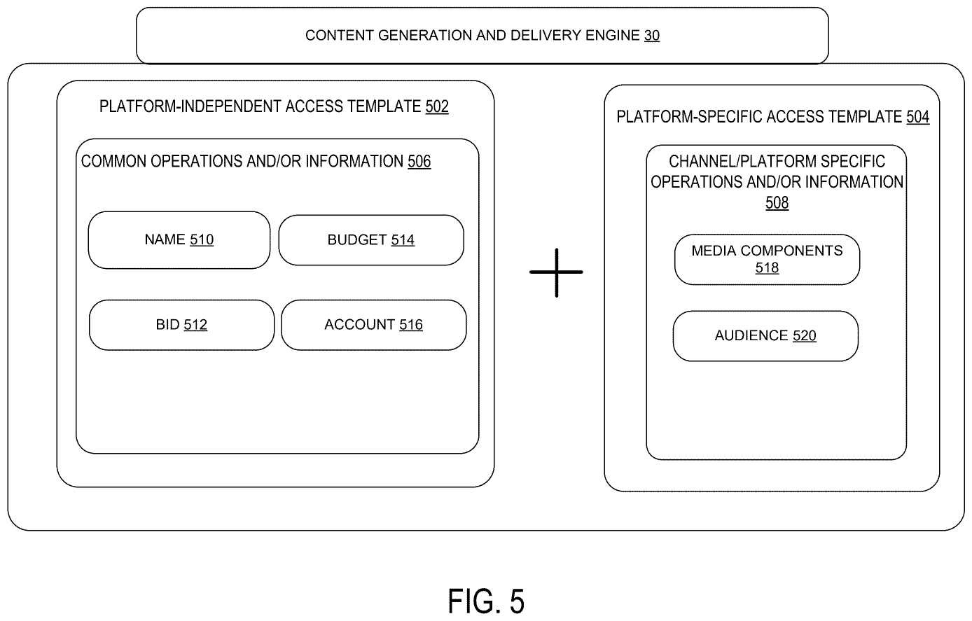

Different media platforms 32, 34, 36 may have different operations and/or may use different information, which makes it a challenging task to efficiently deliver the generated content to a plurality of media platforms. In the disclosed computing system 10, to facilitate the content delivery to different media platforms (or different data channels), the content generation and delivery engine 30 generates and/or implements a platform-independent access template and a platform-specific access template. FIG. 5 shows a schematic view of a platform-independent access template 502 and a platform-specific access template 504 generated and/or implemented by the content generation and delivery module 30 included in the computing system 10 of FIG. 1. As shown in FIG. 5, the platform-independent access template 502 may be generated and/or implemented to include common operations and/or information 506 related to different application programming interfaces (APIs) implemented at various media platforms 32, 34, 36. The common operations and/or information 506 may include, for example, a name 510, a bid 512, a budget 514, and an account 516. Other common operations and/or information may also be included in the platform-independent access template 502. A plurality of different platform-specific access templates 504 may be generated and/or implemented by the content generation and delivery engine 30. Each platform-specific access template 504 may be generated and/or implemented to include channel/platform specific, non-common operations and/or information 508, which may include platform-specific media components 518 and platform-specific audience 520. When the content generation and delivery engine 30 generates the platform-specific access platform 504, the platform-specific access platform 504 may include platform-specific campaign metadata that includes platform-specific data or information for generating and delivering the content. Such metadata may include information relating to the media components specifically used in a media platform, and/or information relating to an audience specific to the media platform. The metadata may also include other information such as platform specific content delivery formats, durations (cycles), etc.

It is understood that in some examples, when the computing system 10 is associated with a media platform, the media platforms 32, 34, 36 may be understood as different data channels 32, 34, 36 of the same media platform associated with the computing system 10. The different data channels may involve different operations and/or may use different information for content delivery to user devices 40. The platform-independent access template may be understood as channel-independent access template, and the platform-specific access template may be understood as channel-specific access template. The overall disclosed system and method for content generation and delivery to the user devices 40 through the media platforms 32, 34, 36 may be understood as system and method for content generation and delivery to the user devices 40 through different data channels 32, 34, 36. For illustrative and discussion purposes, the descriptions of the system and method for content generation and delivery use different media platforms 32, 34, 36 as examples.

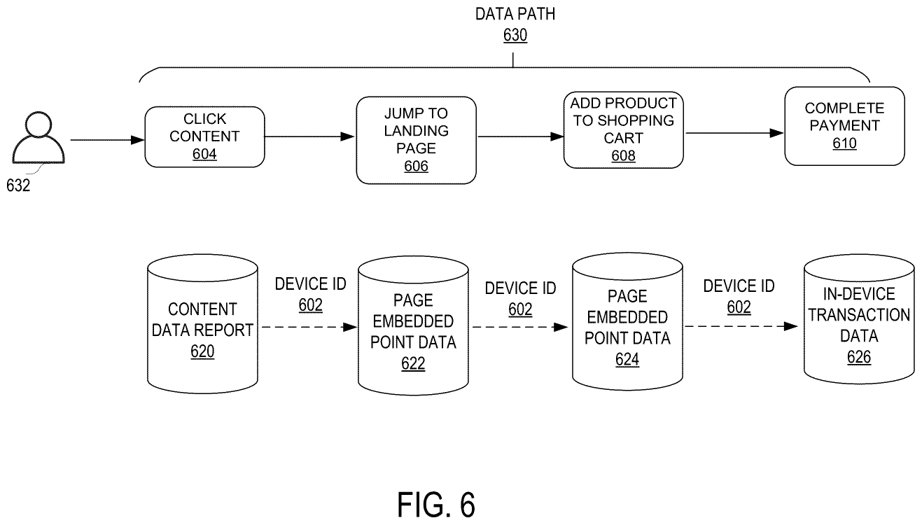

FIG. 6 shows a schematic view of a process of associating a device identification with selected user interactions with displayed content along a data path, which is performed by the computing system 10 of FIG. 1. The computing system 10 may associate, through a function provided by the content generation and delivery program 42 or the content generation and delivery engine 30, a device identification 602 of a user device of a user with selected user interactions with the content displayed at the user device along a data path 630 extending from user clicking the displayed content to user completing a transaction of the selected seller offering promoted by the displayed content. As shown in FIG. 6, along the data path 630, a user 632 may perform or experience a number of actions while interacting with the displayed content, such as an action 604 of clicking a displayed content, an action 606 of jumping to a landing page (which may be an action experienced by the user 632), an action 608 of adding a product promoted in the displayed content to a shopping cart, and an action 610 of completing a payment for the purchase of the product. A landing page may be a page displayed on a user device as a result of the user clicking a hyperlink or a hyperlinked image or video shown in the displayed content. In some examples, the user 632 may click the displayed content or a portion thereof to jump to a first landing page and make a purchase of a product on the first landing page. In some examples, after jumping to a first landing page, the user may click additional content displayed on the first landing page to jump to a second landing page and make a purchase on the second landing page, and so on. It is understood that the user may take or experience various actions when interacting with the displayed content, and some of the actions may be selected as significant actions. These significant actions taken or experienced by the user along the data path 630 may be associated with a device identification of the user device on which the content is displayed. For example, when the user 632 clicks the content displayed on a user device, a content data report 620 may be generated, for example, through a function provided by the content generation and delivery program 42 or the content generation and delivery engine 30. The content data report 620 may associate the action 604 of the user clicking the displayed content with the device identification 602 of the user device. When the user clicks the displayed content and jumps to a landing page, page embedded point data 622 may be collected or generated, for example, through a function provided by the content generation and delivery program 42 or the content generation and delivery engine 30. In the page embedded point data 622, the device identification 602 may be associated with the action 606 of jumping to the landing page. When the user adds the product to the shopping cart, additional page embedded point data 624 may be collected or generated, for example, through a function provided by the content generation and delivery program 42 or the content generation and delivery engine 30. In the page embedded point data 624, the device identification 602 may be associated with the action 608 of the user adding the product to the shopping cart. When the user completes a payment, in-device transaction data 626 may be collected or generated, for example, through a function provided by the content generation and delivery program 42 or the content generation and delivery engine 30. In the in-device transaction data 626, the device identification 602 may be associated with the action 610 of completing the payment.

By associating the device identification 602 with the selected user interactions with the displayed content along the data path 630, the computing system 10 is enabled to perform attribute analysis on a large amount of order data. Examples of the attributes analyzed may include attribute window (e.g., payment time—click time), last click (e.g., arranged in order according to the click time within the window period), quasi order (e.g., quasi-settlement orders). Results from such analyses can be used to configure settings on content generation and delivery to maximize the content generation and delivery effectiveness measurement, such as the return on investment.

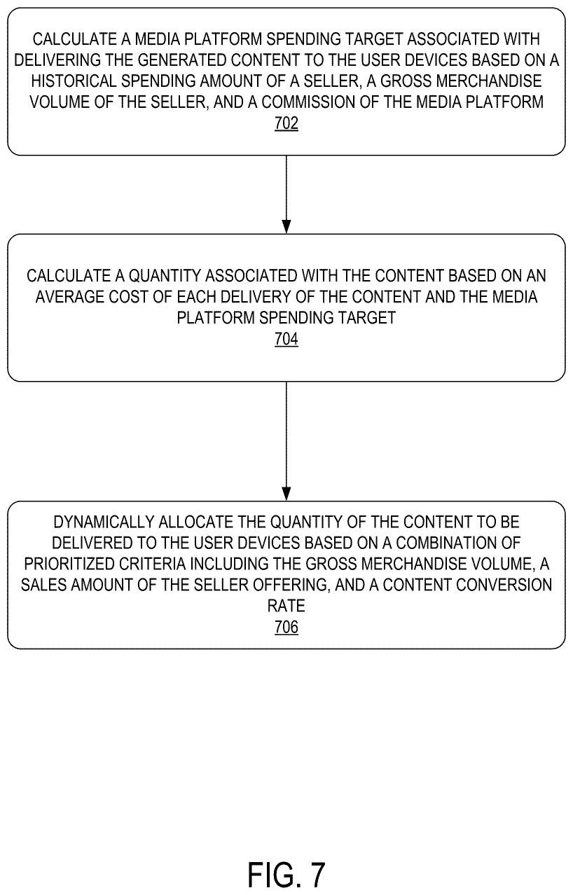

FIG. 7 is a flowchart of an example method for dynamically allocating an amount of content to be delivered, which is performed by the computing system 10 of FIG. 1. The method may be provided by the content generation and delivery engine 30 or other function modules or engines of the content generation and delivery program 42. In order to balance a seller spending target of the seller and a media platform spending target of the media platform that distributes the content to the user devices, the computing system 10 may calculate a media platform spending target (or budget) based on a seller pre-configured spending target (or budget), and may dynamically generate and deliver content to user devices according to the calculated media platform spending target and a combination of prioritized criteria.

As shown in FIG. 7, the method includes calculating a media platform spending target associated with delivering the generated content to the user devices based on a historical spending amount of a seller, a gross merchandise volume of the seller, and a commission of the media platform (step 702). In one example, a lifetime value (LTV) prediction model may be used to limit the media platform spending target to be within (e.g., smaller than or equal to) a pre-set percentage of a monthly gross merchandise volume (GMV) of the seller. It is understood that as the monthly GMV of the seller changes, the media platform spending target may also change. The method also includes calculating a quantity associated with the content based on an average cost of each delivery of the content and the media platform spending target (step 704). In some examples, the average cost of each delivery of the content may be an average cost of each delivery of the content (e.g., each advertisement) within the past 14 days (or a week, a month, etc.). The quantity associated with the content may be a quantity of content to be generated and delivered, which may be calculated by dividing the media platform spending target by the average cost of each delivery of the content. The method further includes dynamically allocating the quantity of the content to be delivered to the user devices based on a combination of prioritized criteria including the gross merchandise volume, a sales amount of the seller offering, and a content conversion rate (step 706). The gross merchandise volume may have a higher priority than the sales amount of the seller offering, which may have a higher priority than the content conversion rate. The computing system 10 may analyze feedback data collected during the content delivery process to dynamically adjust the quantity of the content to be generated and the allocation of the generated content to be delivered to different media platforms and/or user devices. It is noted that additional steps may be included in the method shown in FIG. 7, or some steps shown in FIG. 7 may be omitted from the method. It is understood that the method for automatically generating and delivering content may be formed by various combinations of the steps, processes, or functions described and/or illustrated in the present disclosure.

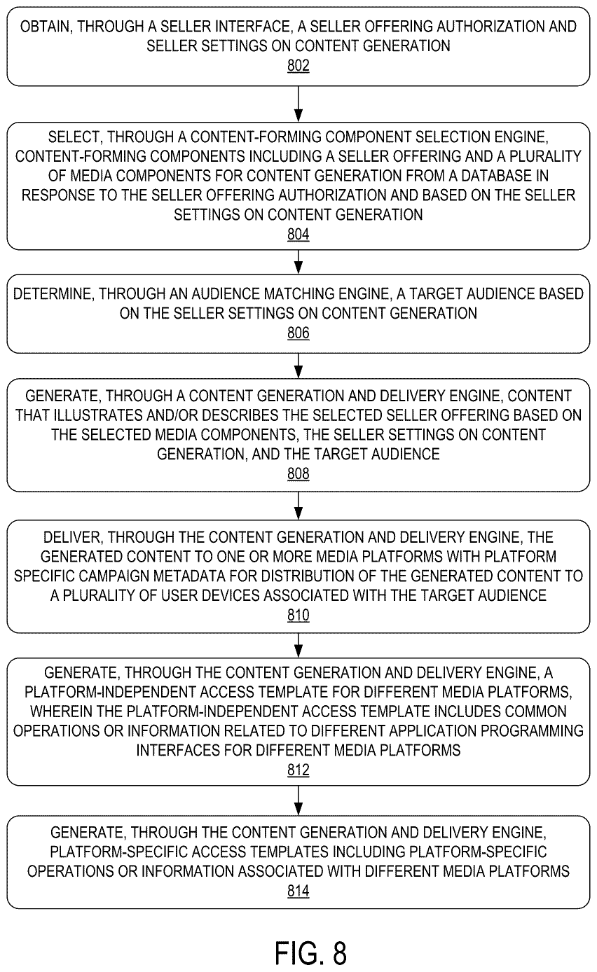

FIG. 8 is a flowchart of an example method for automatic content generation and delivery, which is performed by the computing system 10 of FIG. 1. The method shown in FIG. 8 includes obtaining, through a seller interface, a seller offering authorization and seller settings on content generation (step 802). The method also includes selecting, through a content-forming component selection engine, content-forming components including a seller offering and a plurality of media components for content generation from a database in response to the seller offering authorization and based on the seller settings on content generation (step 804). The method also includes determining, through an audience matching engine, a target audience based on the seller settings on content generation (step 806). The method also includes generating, through a content generation and delivery engine, content that illustrates and/or describes the selected seller offering based on the selected media components, the seller settings on content generation, and the target audience (step 808). The method also includes delivering, through the content generation and delivery engine, the generated content to one or more media platforms with platform specific campaign metadata for distribution of the generated content to a plurality of user devices associated with the target audience (step 810). The method also includes generating, through the content generation and delivery engine, a platform-independent access template for different media platforms, wherein the platform-independent access template includes common operations or information related to different application programming interfaces for different media platforms (step 812). The method further includes generating, through the content generation and delivery engine, platform-specific access templates including platform-specific operations or information associated with different media platforms (step 814). It is noted that additional steps may be included in the content generation and delivery method shown in FIG. 8, or some steps shown in FIG. 8 may be omitted from the content generation and delivery method. It is understood that the method for automatically generating and delivering content may be formed by various combinations of the steps, processes, or functions described and/or illustrated in the present disclosure.

In some embodiments, the methods and processes described herein may be tied to a computing system of one or more computing devices. In particular, such methods and processes may be implemented as a computer-application program or service, an API, a library, and/or other computer-program product.

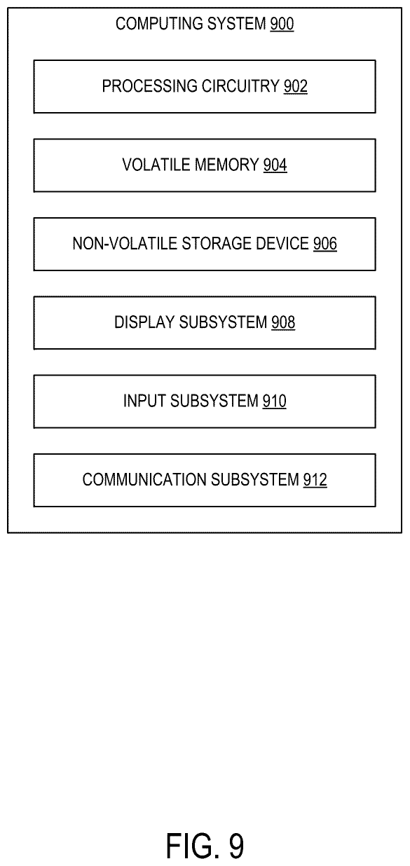

FIG. 9 schematically shows a non-limiting example of a computing system 900 that can enact one or more of the methods and processes described above. Computing system 900 is shown in simplified form. Computing system 900 may embody the computing system 10 described above and illustrated in FIG. 1. Components of computing system 900 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 900 includes processing circuitry 902, volatile memory 904, and a non-volatile storage device 906. Computing system 900 may optionally include a display subsystem 908, input subsystem 910, communication subsystem 912, and/or other components not shown in FIG. 9.

Processing circuitry 902 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 902 may be single-core or multi-core, and the instructions executed thereon may be configured for sequential, parallel, and/or distributed processing. Individual components of the processing circuitry 902 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 902.

Non-volatile storage device 906 includes one or more physical devices configured to hold instructions executable by the processing circuitry 902 to implement the methods and processes described herein. When such methods and processes are implemented, the state of non-volatile storage device 906 may be transformed—e.g., to hold different data.

Non-volatile storage device 906 may include removable and/or built-in physical devices. Non-volatile storage device 906 may include optical memory, semiconductor memory, and/or magnetic memory, or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by processing circuitry 902 to temporarily store information during processing of software instructions. It will be appreciated that volatile memory 904 typically does not continue to store instructions when power is cut to the volatile memory 904.

Aspects of processing circuitry 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), SOC, and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via processing circuitry 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with processing circuitry 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, camera, or microphone.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 900 to send and/or receive messages to and/or from other devices via a network such as the Internet.

Various examples have been described and illustrated for automatically and dynamically generating and delivering content (e.g., advertisement) to a plurality of user devices associated with a target audience. With the disclosed computing system, large-scale content delivery may be achieved automatically with minimal operator intervention, thereby increasing efficiency and cost-effectiveness of content generation and delivery.

In some examples, a computing system is disclosed. The computing system includes processing circuitry and memory storing a content generation and delivery program that, when executed by the processing circuitry, causes the processing circuitry to: obtain, through a seller interface, a seller offering authorization and seller settings on content generation. The processing circuitry is also configured to select, through a content-forming component selection engine, content-forming components including a seller offering and a plurality of media components for content generation from a database in response to the seller offering authorization and based on the seller settings on content generation. The processing circuitry is also configured to determine, through an audience matching engine, a target audience based on the seller settings on content generation. The processing circuitry is also configured to generate, through a content generation and delivery engine, content that illustrates and/or describes the selected seller offering based on the selected media components, the seller settings on content generation, and the target audience. The processing circuitry is further configured to deliver, through the content generation and delivery engine, the generated content to one or more media platforms with platform specific campaign metadata for distribution of the generated content to a plurality of user devices associated with the target audience.

In some examples, the processing circuitry is further configured to: obtain, through a promoter interface, a promoter authorization; and select, through the content-forming component selection engine, one or more media components related to a promoter based on the promoter authorization. In some examples, the seller settings on content generation include a media platform selection factor.

In some examples, the processing circuitry is configured to execute the content generation and delivery program that programmatically performs or causes the performance of the selecting of the content-forming components, the determining of the target audience, the generating of the content, and the delivering of the generated content. In some examples, the processing circuitry is configured to execute the content generation and delivery program that defines a pipeline that includes a plurality of nodes, each node being associated with an operation performed by one or more of the content-forming component selection engine, the audience matching engine, and the content generation and delivery engine.

In some examples, the database is configured to store a plurality of candidate content-forming components including one or more seller offerings, one or more links to live streaming virtual rooms, videos, audios, images, and/or texts. In some examples, when the processing circuitry determines the target audience, the processing circuitry is configured to generate audience groups and deep event statistics that reflect historical user interactions with historically displayed content.

In some examples, when executing the content generation and delivery program, the processing circuitry is further configured to implement one or more standardized input parameters and one or more standardized output parameters for steps of selecting the content-forming components and determining the target audience. In some examples, the processing circuitry is further configured to: generate, through the content generation and delivery engine, a platform-independent access template for different media platforms, wherein the platform-independent access template includes common operations or information related to different application programming interfaces for different media platforms. The processing circuitry is also configured to generate, through the content generation and delivery engine, platform-specific access templates including platform-specific operations or information associated with different media platforms.

In some examples, the processing circuitry is further configured to: associate a device identification of a user device with selected user interactions with the content displayed at the user device along a data path extending from user clicking the displayed content to user completing a transaction of the selected seller offering promoted by the displayed content.

In some examples, the processing circuitry is further configured to: calculate a media platform spending target associated with delivering the generated content to the user devices based on a historical spending amount of a seller, a gross merchandise volume of the seller, and a commission of the media platform. In some examples, the processing circuitry is also configured to calculate a quantity associated with the content based on an average cost of each delivery of the content and the media platform spending target. In some examples, the processing circuitry is also configured to dynamically allocate the quantity of the content to be delivered to the user devices based on a combination of prioritized criteria including the gross merchandise volume, a sales amount of the seller offering, and a content conversion rate.

In some examples, a method implemented by a computing system is provided. The method includes obtaining, through a seller interface of the computing system, a seller offering authorization and seller settings on content generation. The method also includes selecting, through a content-forming component selection engine of the computing system, content-forming components including a seller offering and a plurality of media components for content generation from a database in response to the seller offering authorization and based on the seller settings on content generation. The method also includes determining, through an audience matching engine of the computing system, a target audience based on the seller settings on content generation. The method also includes generating, through a content generation and delivery engine of the computing system, content that illustrates and/or describes the selected seller offering based on the selected media components, the seller settings on content generation, and the target audience. The method further includes delivering, through the content generation and delivery engine, the generated content to one or more media platforms with platform specific campaign metadata for distribution of the generated content to a plurality of user devices associated with the target audience.

In some examples, the method also includes obtaining, through a promoter interface of the computing system, a promoter authorization. The method also includes selecting, through the content-forming component selection engine, one or more media components related to a promoter based on the promoter authorization. In some examples, the seller settings on content generation include a media platform selection factor. In some examples, the selecting of the media components, the determining of the target audience, the generating of the content, and the delivering of the generated content are programmatically performed.

In some examples, the content-forming components include one or more seller offerings, one or more links to one or more live streaming virtual rooms, videos, audios, images, and/or texts. In some examples, determining the target audience includes generating audience groups and deep event statistics that reflect historical user interactions with historically displayed content. In some examples, the method also includes implementing, through the computing system, one or more standardized input parameters and one or more standardized output parameters for steps of selecting content-forming components and determining the target audience.

In some examples, the method includes generating, through the content generation and delivery engine, a platform-independent access template for different media platforms, wherein the platform-independent access template includes common operations or information related to different application programming interfaces for different media platforms. The method also includes generating, through the content generation and delivery engine, platform-specific access templates for non-common operations or information associated with different media platforms.

In some examples, a computing system is provided. The computing system includes processing circuitry and memory storing a content generation and delivery program that, when executed by the processing circuitry, causes the processing circuitry to: select, through a content-forming component selection engine, content-forming components including a seller offering and a plurality of media components for content generation from a database in response to a seller offering authorization and based on seller settings on content generation and a promoter authorization. The processing circuitry is also configured to determine, through an audience matching engine, a target audience based on the seller settings on content generation. The processing circuitry is also configured to generate, through a content generation and delivery engine, content that illustrates and/or describes the selected seller offering based on the selected content-forming components, the seller settings on content generation, and the target audience, wherein the seller settings on content generation include a media platform selection factor. The processing circuitry is also configured to deliver, through the content generation and delivery engine, the generated content to one or more media platforms with platform specific campaign metadata for distribution of the generated content to a plurality of user devices associated with the target audience.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing a content generation and delivery program that, when executed by the processing circuitry, causes the processing circuitry to:
obtain, through a seller interface, a seller offering authorization and seller settings on content generation;
select, through a content-forming component selection engine, content-forming components including a seller offering and a plurality of media components for content generation from a database in response to the seller offering authorization and based on the seller settings on content generation;
determine, through an audience matching engine, a target audience based on the seller settings on content generation;
generate, through a content generation and delivery engine, content that illustrates and/or describes the selected seller offering based on the selected media components, the seller settings on content generation, and the target audience; and
deliver, through the content generation and delivery engine, the generated content to one or more media platforms with platform specific campaign metadata for distribution of the generated content to a plurality of user devices associated with the target audience.

2. The computing system of claim 1, wherein the processing circuitry is further configured to:
obtain, through a promoter interface, a promoter authorization; and
select, through the content-forming component selection engine, one or more media components related to a promoter based on the promoter authorization.

3. The computing system of claim 1, wherein the seller settings on content generation include a media platform selection factor.

4. The computing system of claim 1, wherein the processing circuitry is configured to execute the content generation and delivery program that programmatically performs or causes the performance of the selecting of the content-forming components, the determining of the target audience, the generating of the content, and the delivering of the generated content.

5. The computing system of claim 1, wherein the processing circuitry is configured to execute the content generation and delivery program that defines a pipeline that includes a plurality of nodes, each node being associated with an operation performed by one or more of the content-forming component selection engine, the audience matching engine, and the content generation and delivery engine.

6. The computing system of claim 1,
wherein the database is configured to store a plurality of candidate content-forming components including one or more seller offerings, one or more links to one or more live streaming virtual rooms, videos, audios, images, and/or texts.

7. The computing system of claim 1,
wherein when the processing circuitry determines the target audience, the processing circuitry is configured to generate audience groups and deep event statistics that reflect historical user interactions with historically displayed content.

8. The computing system of claim 1,
wherein when executing the content generation and delivery program, the processing circuitry is further configured to implement one or more standardized input parameters and one or more standardized output parameters for steps of selecting the content-forming components and determining the target audience.

9. The computing system of claim 1, wherein the processing circuitry is further configured to:
generate, through the content generation and delivery engine, a platform-independent access template for different media platforms, wherein the platform-independent access template includes common operations or information related to different application programming interfaces for different media platforms; and
generate, through the content generation and delivery engine, platform-specific access templates including platform-specific operations or information associated with different media platforms.

10. The computing system of claim 1, wherein the processing circuitry is further configured to:
associate a device identification of a user device with selected user interactions with the content displayed at the user device along a data path extending from user clicking the displayed content to user completing a transaction of the selected seller offering promoted by the displayed content.

11. The computing system of claim 1, wherein the processing circuitry is further configured to:
calculate a media platform spending target associated with delivering the generated content to the user devices based on a historical spending amount of a seller, a gross merchandise volume of the seller, and a commission of the media platform;
calculate a quantity associated with the content based on an average cost of each delivery of the content and the media platform spending target; and
dynamically allocate the quantity of the content to be delivered to the user devices based on a combination of prioritized criteria including the gross merchandise volume, a sales amount of the seller offering, and a content conversion rate.

12. A method implemented by a computing system, comprising:
obtaining, through a seller interface of the computing system, a seller offering authorization and seller settings on content generation;
selecting, through a content-forming component selection engine of the computing system, content-forming components including a seller offering and a plurality of media components for content generation from a database in response to the seller offering authorization and based on the seller settings on content generation;
determining, through an audience matching engine of the computing system, a target audience based on the seller settings on content generation;
generating, through a content generation and delivery engine of the computing system, content that illustrates and/or describes the selected seller offering based on the selected media components, the seller settings on content generation, and the target audience; and
delivering, through the content generation and delivery engine, the generated content to one or more media platforms with platform specific campaign metadata for distribution of the generated content to a plurality of user devices associated with the target audience.

13. The method of claim 12, further comprising:
obtaining, through a promoter interface of the computing system, a promoter authorization; and
selecting, through the content-forming component selection engine, one or more media components related to a promoter based on the promoter authorization.

14. The method of claim 12, wherein the seller settings on content generation include a media platform selection factor.

15. The method of claim 12, wherein the selecting of the media components, the determining of the target audience, the generating of the content, and the delivering of the generated content are programmatically performed.

16. The method of claim 12,
wherein the content-forming components comprise one or more seller offerings, one or more links to one or more live streaming virtual rooms, videos, audios, images, and/or texts.

17. The method of claim 12,
wherein determining the target audience comprises generating audience groups and deep event statistics that reflect historical user interactions with historically displayed content.

18. The method of claim 12, further comprising:
implementing, through the computing system, one or more standardized input parameters and one or more standardized output parameters for steps of selecting content-forming components and determining the target audience.

19. The method of claim 12, further comprising:
generating, through the content generation and delivery engine, a platform-independent access template for different media platforms, wherein the platform-independent access template includes common operations or information related to different application programming interfaces for different media platforms; and
generating, through the content generation and delivery engine, platform-specific access templates for non-common operations or information associated with different media platforms.

20. A computing system, comprising:
processing circuitry and memory storing a content generation and delivery program that, when executed by the processing circuitry, causes the processing circuitry to:
select, through a content-forming component selection engine, content-forming components including a seller offering and a plurality of media components for content generation from a database in response to a seller offering authorization and based on seller settings on content generation and a promoter authorization;
determine, through an audience matching engine, a target audience based on the seller settings on content generation;
generate, through a content generation and delivery engine, content that illustrates and/or describes the selected seller offering based on the selected content-forming components, the seller settings on content generation, and the target audience, wherein the seller settings on content generation include a media platform selection factor; and
deliver, through the content generation and delivery engine, the generated content to one or more media platforms with platform specific campaign metadata for distribution of the generated content to a plurality of user devices associated with the target audience.
